(19) United States
(12) Patent Application Publication
(10) Pub. No.: US 2003/0205883 A1
(43) Pub. Date: Nov. 6, 2003

(54) Wheelchair with seat height adjustment, arm articulation and seat translation

(76) Inventors: Michele R Bergstrom, Norwood, MA (US); Peter Lindenmuth, Boston, MA (US)

Correspondence Address: FISH & RICHARDSON PC, 225 FRANKLIN ST, BOSTON, MA, 02110, US

(21) Appl. No.: 10/275,316

(22) PCT Filed: May 9, 2001
(86) PCT No.: PCT/US01/15000

(51) Int. Cl. B62M 1/14

(52) U.S. Cl. 280/304.1

(57) ABSTRACT

A wheelchair including at least one of the following features: (a) a patient support assembly that includes a seat (2) and a back (3) that move vertically together between the operative position and the transfer position; (b) a patient support assembly that is attached to a threaded member (15) that rotates to raise the patient support assembly; and/or (c) an articulating support for at least one of the wheels (6) comprising at least two slides (12), one of the slides (12) being attached to the wheel (6) and the other of the slides (12) being attached to the base, so that the wheel moves laterally to facilitate transfer.

### TECHNICAL FIELD

This invention relates to wheelchairs and more particularly to wheelchairs that facilitate user transfer into and out of the chair.

### BACKGROUND

Bergstrom U.S. Pat. No. 5,520,403 (the '403 patent) discloses a wheelchair with a set of features that facilitate patient transfer to an alternative surface. The wheels are independently pivoted rearward by raising the armrest. A lifting mechanism raises the patient to the level of an alternative surface such as a bed. The seat surface is fabricated from a moveable belt that laterally transports the patient. The '403 patent is hereby incorporated by reference in its entirety.

### SUMMARY

Several objects and advantages of the present invention include:

a. raising the patient to the level of a bed or other suitable surface and lowering the patient to a normal wheelchair operating height after transferring from a bed or other surface.

b. a seat having ability to laterally transport the patient toward a bed or other surface (preferably bidirectionally, i.e., on either side of the chair).

c. a wheel-lock mechanism for use during transfer.

d. the armrests articulate out of the way to facilitate transfer, and the arm-articulation mechanism is coupled to the wheel-rearward articulating mechanism.

Another object is to provide a wheelchair with an improved mechanism to raise the seat.

Another object is to provide a wheelchair with an improved mechanism to translate the patient laterally.

Another object is to provide a wheelchair with an improved mechanism to raise the patient to transfer level.

A further object is to provide a wheelchair wherein the seat raising mechanism and/or the seat translating mechanism are power driven.

Another object is to provide motors to the wheels to propel the chair.

Additional objects will be obvious to those skilled in the art from the drawings and detailed description that follows.

The invention generally features wheelchairs (both hand-operated and motor-powered) that include one or more (preferably all) of the following features:

a. a patient support assembly that is moveable vertically with respect to the base between i) an operative position in which the patient support maintains the patient at an operational height for rolling the wheelchair on the wheels, and ii) a patient transfer position, higher than the operative position, to facilitate patient transfer into or out of the chair; the patient support assembly includes a seat and a back that move vertically together between the operative position and the transfer position;

b. a patient support assembly that is moveable vertically with respect to the base between i) an operative position in which the patient support maintains the patient at an operational height for rolling the wheelchair on the wheels, and ii) a patient transfer position, higher than the operative position, to facilitate patient transfer into or out of the chair, the patient support assembly being attached to a threaded member that rotates to raise the assembly; and

c. an articulating support for at least one of the wheels, the wheel support being movably attached to the base to move the wheel rearward so the wheel does not obstruct patient transfer, the articulating support comprising at least two slides, one of the slides being attached to the wheel and the other of the slides being attached to the base, so that the wheel moves rearwardly to facilitate transfer.

Preferably, the wheelchair includes one or more armrests for patient arm support, in addition to element a and element b, detailed above. The armrest is attached to the patient support assembly so that the armrest moves vertically as the patient support assembly moves from the operative position to the transfer position. In this way, the patient has the security of a back as well as an armrest during the transfer. For the same reason, an attachment for footrests may be connected to the patient support assembly. Stability can be further enhanced if the armrest comprises guards that restrict movement of the armrest laterally away from the patient support assembly, so that stress on the armrest tubing during patient transfer is limited. A wheel lock locks the wheels when the chair is in the patient transfer position. The threaded member (screw) can be separately powered by an electric motor to move the patient support vertically between the operative position and the transfer position.

The patient support assembly includes a seat that is moveable laterally with respect to the base between i) a central position in which the patient support maintains the patient in a generally central position; and ii) a laterally-offset patient-transfer position, to facilitate patient transfer into or out of the chair. The patient support assembly includes a platform attached to a belt, the belt being supported by rollers that permit the belt to move laterally. The wheelchair further may include a motor connected to the rollers to provide power to move the belt and transfer the patient laterally between the central position and the offset position.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows the outline of the side view of the chair with the seat and the wheel in their normal positions for wheelchair operation.

FIG. 2 shows a front view of the chair at the side of a bed. The seat has been raised to the height of the bed and moved laterally so that it touches the edge of the bed. The arm at the bedside of the wheelchair has been raised to its most rearward position, thus moving the wheel on that side backward and out of the way to facilitate patient transfer between the chair and the bed.

FIG. 3 shows a rear view of the chair when the seat assembly has been removed and the cross bracing of the frame has been collapsed laterally.

FIG. 4A shows a side view of the chair. The seat has been raised and the arm on the near side has been rotated to its rearmost position as in FIG. 2. FIG. 4B shows a top view of the double slide that connects the rotary motion of the arm to the backward movement of the wheel.

FIGS. 5A and 5B show atop and front view of the cross bracing of the front end of the chair. This structural framework can be collapsed laterally to a small size for easy transport.

FIGS. 6A and 6B show the motors that move the conveyor belt seat and seat subframe.

FIGS. 7A, 7B and 7C depict apparatus for moving the armrest laterally and to prevent it from being accidentally overstressed.

FIGS. 8A (seat down) and 8B (seat up) are highly diagrammatic representations showing the connection between the wheel-back mechanism and the armrest pivot mechanism.

Like reference symbols in the various drawings indicate like elements.

### DETAILED DESCRIPTION

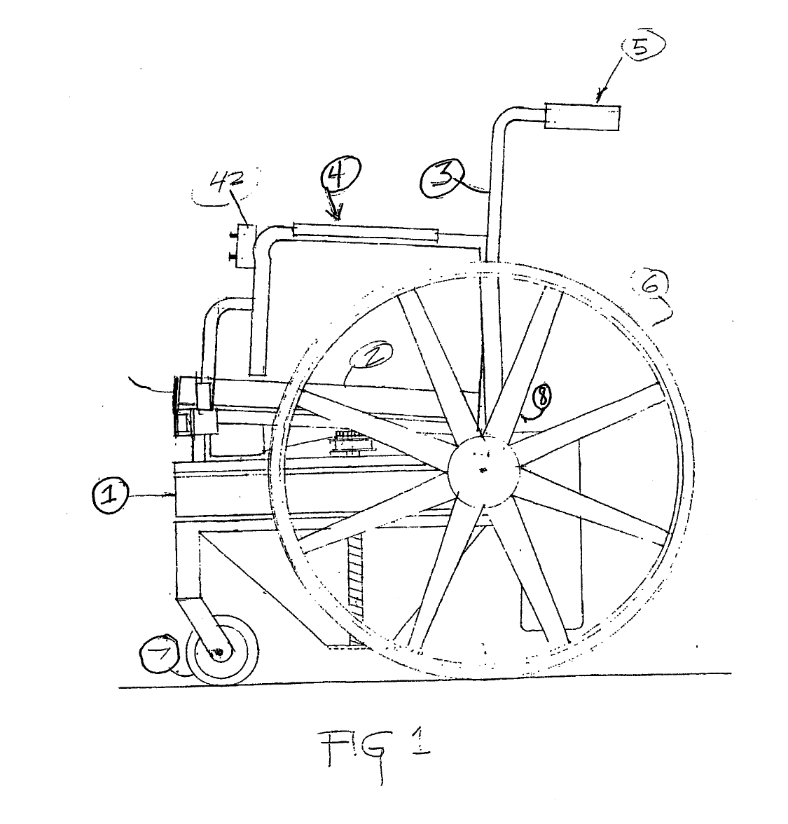

The preferred embodiment of the wheelchair is shown in FIGS. 1 through 8B.

As shown in FIG. 1, the chair consists of a basic frame (1), a conveyor belt-type seat (2), and a seat back (3), armrests (4), handles to move the chair (5), main hand wheels (6) and castored front wheels (7). FIG. 1 shows the outlines of the chair. The basic frame consists of a right side; a left side; wheels on the right and left; a conveyor-type belt seat; a seat back; armrests on the right side and the left side; two handles to move the chair about and; and two castored front wheels; and dual pins and on both sides of the chair for attachable footrests that move up and down with the seat, back, and arms of the chair.

As shown in FIGS. 4A and 4B, the hand wheels (6) are attached to the inner members of ball bearing slides (1′); the arm rest (4) rotates about a pivot (8 in FIG. 4A); only the horizontal component of this rotation is transferred to the back and forth motion of the hand wheel via transfer lever (10) to circular pin (11) then to slide element (12) and finally to wheel-back lever (13). Double track side element (12)—and return spring (14) which retains it reduce the height that the wheel-back lever would otherwise be required in order to couple (10) to (13) when the seat is raised to it's maximum height.

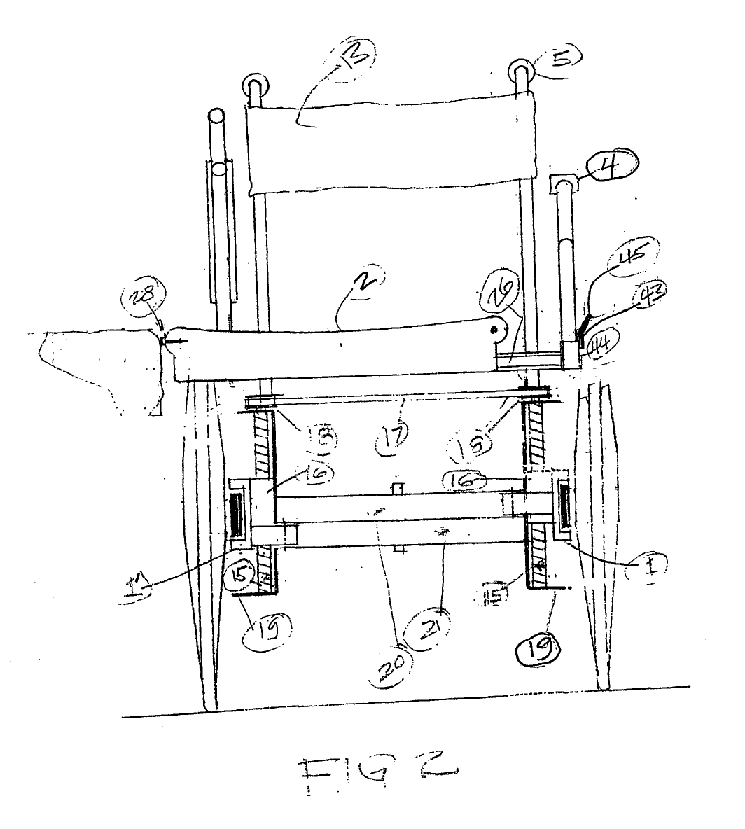

FIG. 2 shows the seat elevating screws (15) and their mating nuts (16), which are rotationally coupled, together by belt (17) and pulleys (18). These screws and their mating nuts (which could either be of the ball type or plain conventional type) elevate channel sections (15) on which the removeable seat assembly (2) (25) (30) etc. is mounted.

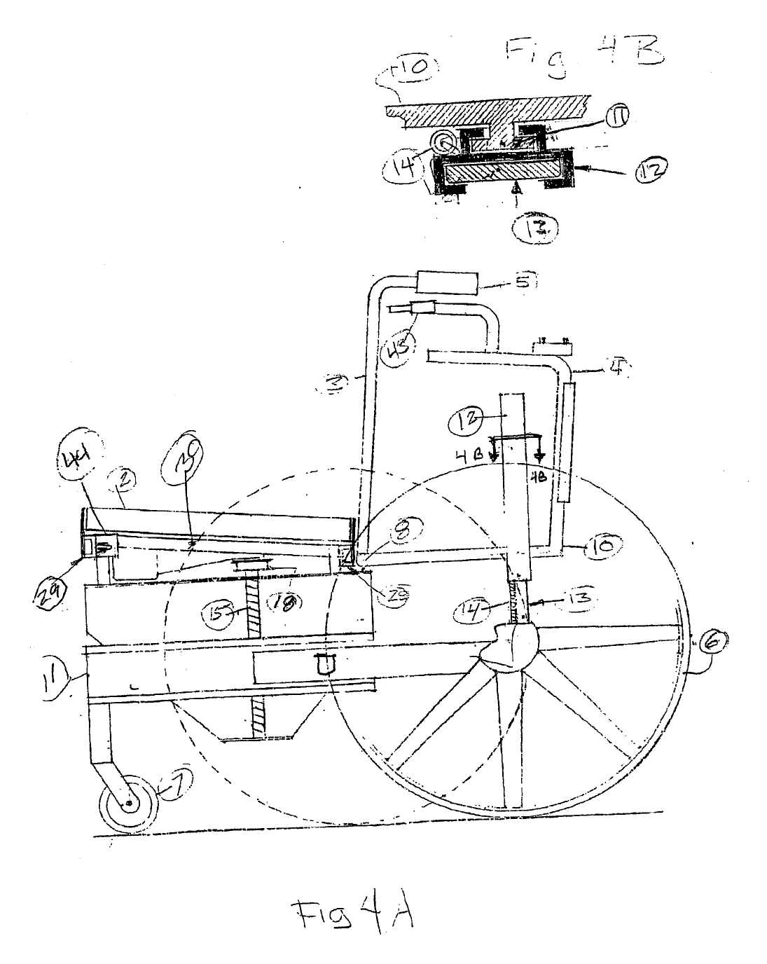

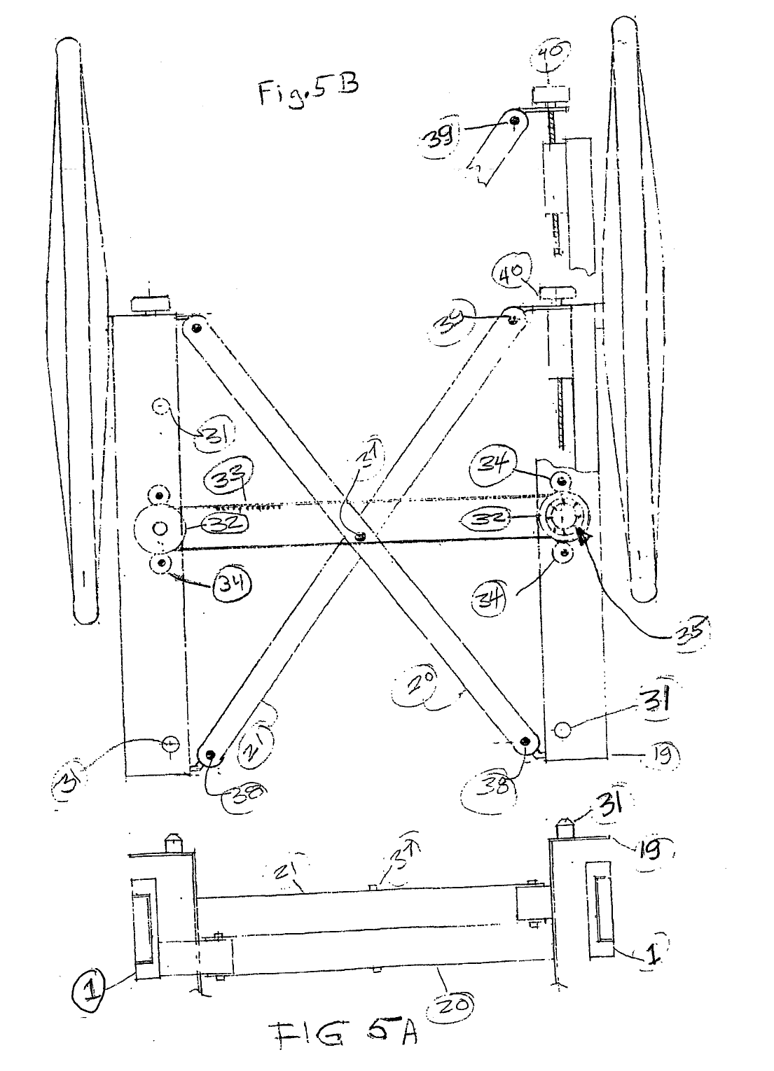

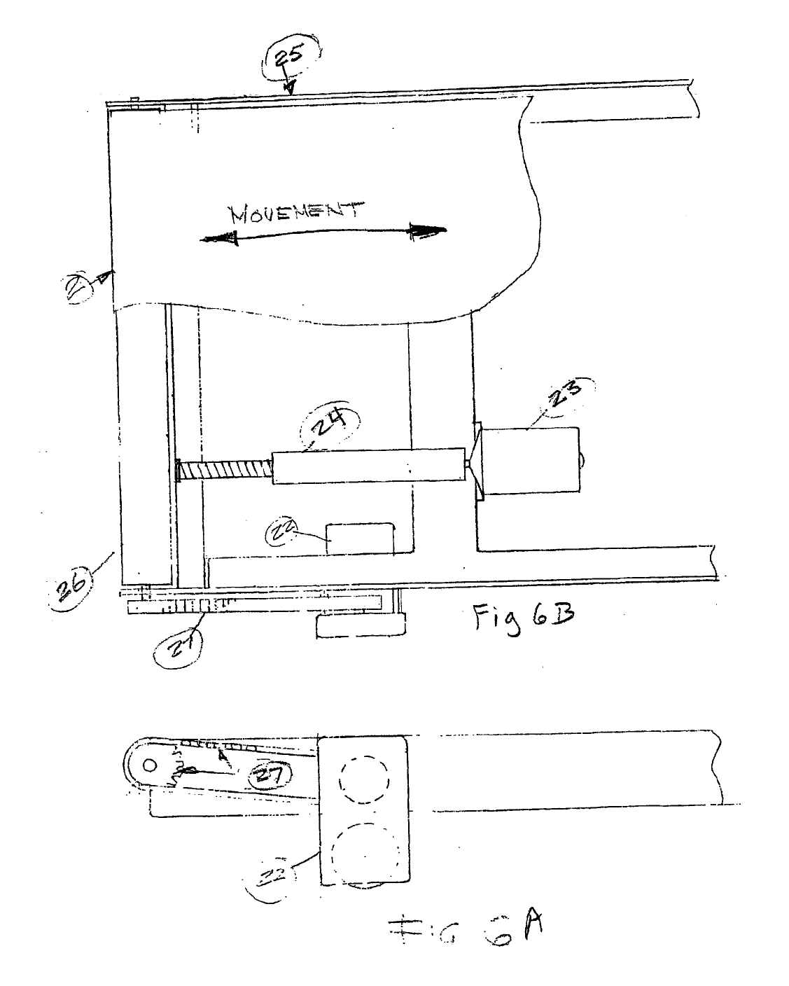

FIG. 2 also shows a front view of the slides (1′) that, together with the collapsing cross bracing (20) and (21), provide the structural frame of the chair. FIGS. 6A and 6B show a top and a back view of the conveyor belt-like seat (2) and the motor (22) that moves the belt as well as the motor (23) and it's screw-type actuator (24) that move the entire top part of the seat assembly (25) latterly either left or right of the structural frame (1) (20) (21) [in FIG. 5A]. The belt (2) moves on rollers (26). The axle of one of these rollers connects to the drive motor (22) via a chain and sprocket drive system (27). FIG. 2 shows the adjusting screws (28) on the axle of the other roller that supports the conveyor like belt (2). These screws are used to tension the belt as well as to “track” it or make it run evenly on the roller. Note that neither the back support nor the armrest moves laterally with the top part of the assembly.

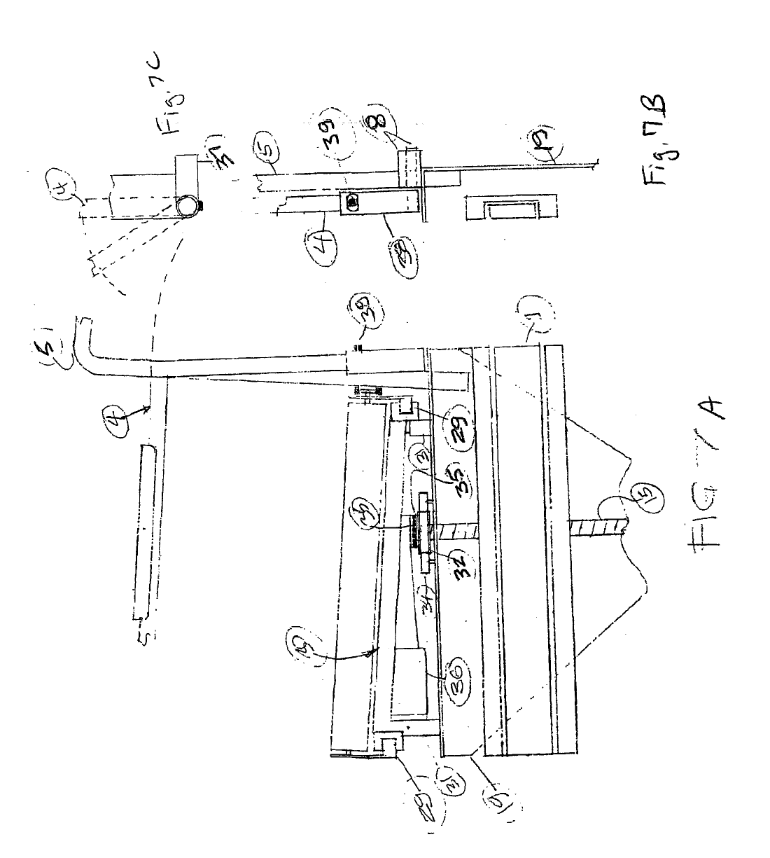

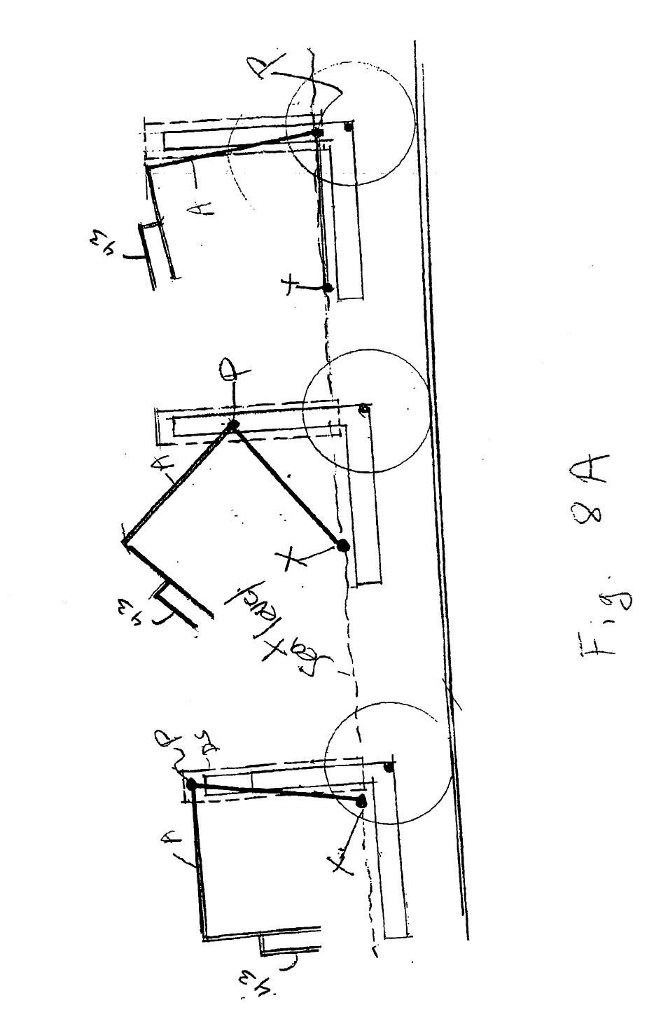

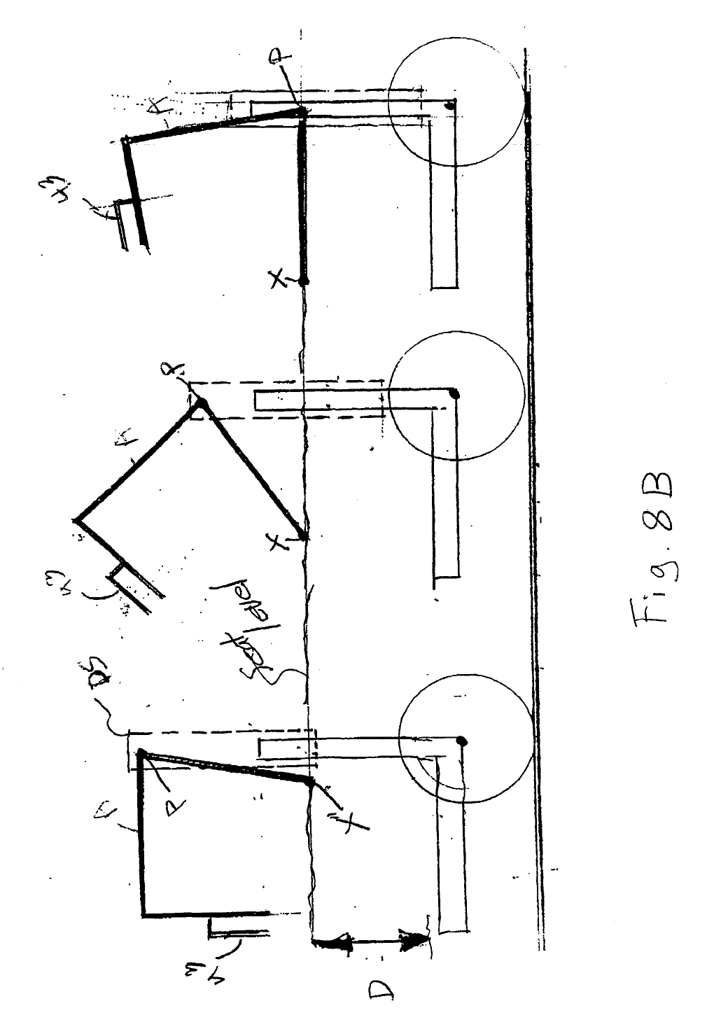

Also in FIG. 5A, the top part of the frame of the seat assembly (25) includes belt (2), rollers (26) and motor (22) and a corresponding motor on the other side (not shown) as well as other associated elements. This seat moves latterly with respect to the main structural frame (1) [FIG. 1] (20) (21) [FIG. 5A] on the inner members of the slides (29) [FIG. 7A]. In FIGS. 7A-7C, the outer part of these slides (29) attaches to the structure of the lower seat frame (30). The lower frame mechanically plugs into the top flange of channel sections (19) on projections (31) as shown in FIGS. 5A and 5B.

FIGS. 5A and 5B show how the elevating screws (15) of FIG. 2 are connected together by gear-like pulleys (32) and a toothed belt (33). Idlers (34) keep the pulleys in contact with the belt when it is slacked as the frame (20) (21) is latterly collapsed for transport. A toothed coupling (35) on top of one of the pulleys connects that pulley, belt and associated elements to the elevating drive motor (36) as shown in FIG. 7A.

FIGS. 5A and 5B also show how cross bracing members (20) and (21) connect to channel sections (19). The cross bracing members pivot about axis (37). Their front ends are rotationally connected to the channel at pivots (38). Their rear ends are both rotationally and slideably connected to the opposite end of the channels via pivots (39) and screw clamp (40), which permit the ends of members (20) and (21) to move rearward as the frame is collapse laterally.

In transferring between the chair and the bed, patients may impose very large lateral loads on the armrests of the wheelchair. (Note that the term armrest and arm are used interchangeably, to denote the entire structure of the arm, not just a cushion, which contacts the patient's arm.) If the front end of the armrest is not in its holster, these lateral loads could bend the structure of the arm. To avoid this, the arms are free to move laterally as well as rotationally front to back. FIGS. 7A, 7B and 7C show a side view, a backside, and a top view, respectively, of the attachment of the arms (4) at the back of the chair. The arm can rotate backwards and forwards about pivot (8). Bearing (38) permits the arm to move laterally or outward. In addition to limiting excessive motion of the arm pin (39) retains it.

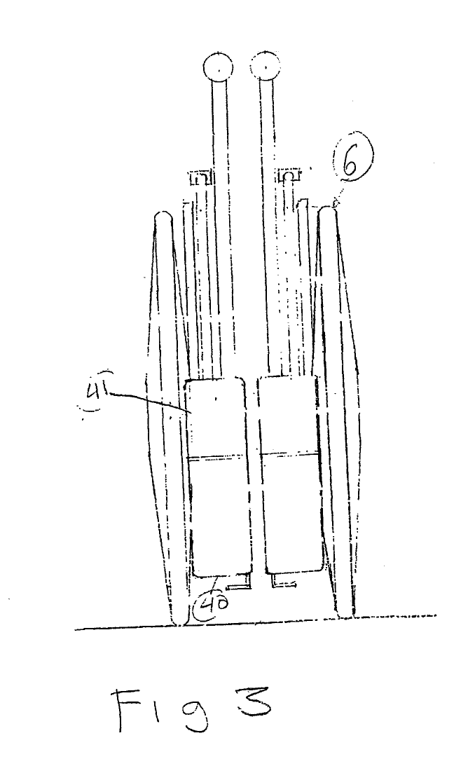

FIG. 3 is a rear view of the chair when it is collapsed laterally by removing the seat (2) (29) (30) [FIG. 7A] etc. and loosening the clamps (40) of the cross bracing.

The chair can be moved about by either using the hand wheels (6) or by the motors (40) at the back of the chair. A chain or gear drive (not shown) couples each wheel to it's motor via a clutch and right angle gearing (41). In one embodiment, coupling is achieved by a differential. The motor connects to the “spider” or input gearing of the differential. The hand wheel connects to one of the output shafts. If the other output shaft is prevented from rotating, the motor is connected to the hand wheel. If the shaft is allowed to freely rotate the motor is disconnected.

Controls for the motors could be attached to the chair's arm as shown by (42) of FIG. 1. A detachable battery pack could be suspended from cross braces (20) and (21) [FIG. 2].

The front ends (43) of arms (4) plug into holsters (44) as shown in FIG. 2, FIG. 4A and FIG. 4B. The end of the arm is prevented from being accidentally withdrawn by snap latch (45). The front ends of lower seat frame member (30) also provide a convenient attachment point for footrests (not shown).

FIGS. 8A and 8B show the movement of points P (see pin 11 in FIG. 4B) and X (see point 8 in FIG. 4A). In FIG. 8A, the seat is maintained in the lower, operating position. As point P rotates rearward around point X the armrest A moves from generally horizontal to generally vertical. Point P is thus translated laterally to the rear, relative to point X in the seat support. In FIG. 8B, the seat support has been raised a distance D above its position in FIG. 8A. Once again, point P pivots rearward of point X, guided by double slide mechanism DS. The front end of the armrest A (43 in FIG. 4A) is also depicted in FIGS. 8A and 8B.

A number of embodiments of the invention have been described. Nevertheless, it will be understood that various modifications may be made without departing from the spirit and scope of the invention. Accordingly, other embodiments are within the scope of the following claims.

What is claimed is:

1. A wheelchair comprising wheels and a base, the base being attached to the wheels, and the wheelchair including at least one of the following features:
a. a patient support assembly that is moveable vertically with respect to the base between i) an operative position in which the patient support assebmly maintains the patient at an operational height for rolling the wheelchair on the wheels, and ii) a patient transfer position, higher than the operative position, to facilitate patient transfer into or out of the chair, the patient support assembly comprising a seat and a back that move vertically together between the operative position and the transfer position;
b. a patient support assembly that is moveable vertically with respect to the base between i) an operative position in which the patient support assembly maintains the patient at an operational height for rolling the wheelchair on the wheels, and ii) a patient transfer position, higher than the operative position, to facilitate patient transfer into or out of the chair, the patient support assembly being attached to a threaded member that rotates to raise the assembly by a direct connection between the member and the assembly; and
c. an articulating support for at least one of the wheels, the wheel support being movably attached to the base to move the wheel rearward for patient transfer, the articulating support comprising at least two slides, one of the slides being attached to the wheel and the other of the slides being attached to the base.

2. The chair according to claim 1 in which the chair comprises element a., element b., or both, and the chair further comprises an armrest that moves vertically as part of the patient support assembly.

3. The chair according to claim 2 in which the chair comprises element c., and the armrests pivot as the articulating wheel support moves rearwardly.

4. The chair according to claim 1 in which the chair comprises element a., element b., or both, and the chair further comprises an attachment for a footrest that moves vertically as part of the patient support assembly.

5. The wheelchair of claim 2 in which the armrest comprises guards that restrict movement of the arm laterally away from the patient support, whereby transfer of stress to the arm during patient transfer is restricted.

6. The wheelchair of claim 1 in which the wheels are hand operated.

7. The wheelchair of claim 1 further comprising an electric motor connected to rotate the wheels.

8. The wheelchair of claim 1 comprising a wheel lock to lock the wheels when the chair is in the patient transfer position.

9. The wheelchair of claim 1 in which the wheels are at least 18 inches in diameter.

10. The wheelchair of claim 1 in which the wheelchair comprises element b, and the threaded member is connected to a motor providing power to move the patient support apparatus vertically.

11. The wheelchair of claim 1 in which the wheelchair comprises a patient support assembly that is moveable laterally with respect to the base between i) a central position in which the patient support maintains the patient in a generally central position; and ii) a laterally-offset patient-transfer position, to facilitate patient transfer into or out of the chair, the patient support mechanism comprising a platform attached to a belt, the belt being supported by rollers that permit the belt to move laterally, and the wheelchair further includes a motor connected to at least one of the rollers to provide power to move the belt and transfer the patient laterally between the central position and the offset position.

12. The wheelchair of claim 1 or claim 11 in which the wheelchair comprises each of elements a.-c.

13. A method of making the wheelchair of claim 1 comprising assembling the base and wheels to an element selected from elements a. through c.

14. A method of using the wheelchair of claim 1 comprising providing the wheelchair and conducting patient transfer into or out of the wheelchair.
